(19) United States
(12) Patent Application Publication
(10) Pub. No.: US 2024/0410380 A1
(43) Pub. Date: Dec. 12, 2024

(54) Ceiling Fan Device

(71) Applicant: Adrenna Bell, Milwaukee, WI (US)

(72) Inventor: Adrenna Bell, Milwaukee, WI (US)

(21) Appl. No.: 18/657,876

(22) Filed: May 8, 2024

Related U.S. Application Data
(60) Provisional application No. 63/472,107, filed on Jun. 9, 2023.

(51) Int. Cl. F04D 25/08; F04D 29/00; H04R 1/02

(52) U.S. Cl. CPC F04D 25/088; F04D 29/005; H04R 1/028; H04R 2201/021

(57) ABSTRACT

The present invention relates to a ceiling fan device that is customizable through electrical communication with a transmitter in a remote, and a receiver in the housing of the device. The device is comprised of a housing, at least one blade, at least one mount, at least one speaker, at least one light, at least one motor, a remote, and a mobile application. Further, the device is in electrical communication with a mobile application on the user's smart device allowing for further control and customization. The device allows a user to play music through the speakers, and control the brightness, colors, and luminosity of the lights for more relaxation.

### CROSS-REFERENCE TO RELATED APPLICATION

The present application claims priority to, and the benefit of, U.S. Provisional Application No. 63/472,107, which was filed on Jun. 9, 2023, and is incorporated herein by reference in its entirety.

### FIELD OF THE INVENTION

The present invention relates generally to the field of fans. More specifically, the present invention relates to a ceiling fan device that is customizable through electrical communication with a transmitter in a remote and a receiver in the housing of the device. The device is comprised of a housing, at least one blade, at least one mount, at least one speaker, at least one light, at least one motor, a remote, and a mobile application. Further, the device is in electrical communication with a mobile application on the user's smart device allowing for further control and customization. The device allows a user to play music through the speakers, and control the brightness, colors, and luminosity of the lights for more relaxation. Accordingly, the present disclosure makes specific reference thereto. Nonetheless, it is to be appreciated that aspects of the present invention are also equally applicable to other like applications, devices, and methods of manufacture.

### BACKGROUND

Many individuals may have trouble sleeping or relaxing in silence or if they are too warm. To combat this, individuals will turn on ceiling fans to cool themselves down. However, it may be inconvenient to be forced to get out of bed and turn a ceiling fan on or to change the intensity of the fan. Further, it may be inconvenient to have to get up to turn on a speaker or a radio needed for further relaxation. Standard ceiling fans have minimal features and may have no way for a user to control the fan remotely. Further, standard fans lack the ability to play music or other sounds.

Therefore, there exists a long-felt need in the art for an improved ceiling fan. There also exists a long-felt need in the art for a ceiling fan device that has remote operating capabilities. In addition, there exists a long-felt need in the art for a ceiling fan device that allows a user to relax by cooling down a room while simultaneously playing music or sounds of their choice. There also exists a long-felt need in the art for a ceiling fan device that has the ability to play music or other sounds. Further, there exists a long-felt need in the art for a ceiling fan device that has lights that are customizable by the user.

The subject matter disclosed and claimed herein, in one embodiment thereof, comprises a ceiling fan device. The device is comprised of a housing, at least one blade, at least one mount, a remote, and a mobile application. The housing is comprised of at least one speaker, at least one light, at least one motor, and at least one receiver. The remote is comprised of a transmitter that is in wireless electrical communication with the receiver to allow the user to control the device via the remote. The receiver is also in wireless electrical communication with a mobile application on the user's smart device, allowing for further customization and control.

In this manner, the ceiling fan device of the present invention accomplishes all of the foregoing objectives and provides a novel ceiling fan device that allows a user to customize the device remotely. The device allows the user to play music through a speaker as well as customize the brightness, luminosity, and color of the lights for further relaxation.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a ceiling fan device. The device is primarily comprised of at least one housing, at least one blade, at least one mount, at least one light, at least one speaker, at least one motor, a remote, and a mobile application.

In differing embodiments, there may be any number of blades on the device. The blades are attached to the housing of the device via at least one fastener. In the preferred embodiment, the blades are removable and interchangeable such that a user can further customize the device. The device also has internal electrical wiring that supplies power to all components of the device. The device is also comprised of a mount that attaches the device to the ceiling. The mount may be attached to the ceiling via a plurality of fastening means.

In the preferred embodiment, at least one light is positioned within the housing of the device. In a differing embodiment, the light may be positioned outside the housing. In either embodiment, the light may be customizable, and allow the user to be able to change the color and/or brightness of the light. The functions of the lights are preferably controllable via a remote that is in wireless electrical communication with the light via a transmitter positioned in the remote and a receiver positioned in the housing. In another embodiment, the functions of the light, such as luminosity, brightness, and color, may be controlled via a mobile application on the user's smart device.

The device is also comprised of at least one motor. The motor powers the device to make the blades rotate around the housing. The motor may have a plurality of intensities to make the blades rotate at different speeds. The motor may also be controlled via the remote that is in wireless electrical communication with the motor via a transmitter positioned in the remote and a receiver positioned in the housing.

The device is also comprised of at least one speaker. The speaker is preferably positioned within the housing, but in differing embodiments, it may be positioned outside of the housing. In the preferred embodiment, the speaker has a plurality of different sound controls and can be controlled via the remote. In another embodiment, the speaker may be controlled via a mobile application on the user's smart device.

The device is also comprised of at least one receiver positioned within the housing of the device. The receiver is in wireless electronic communication with at least one transmitter positioned in the remote. This allows for the transmitter to electronically communicate with the receiver, which then electronically communicates with the speaker, motor, and light. The speaker, motor, or light then executes the appropriate function that was selected on the remote. The receiver also is in wireless electrical communication with the mobile application on the user's smart device. This allows the user to be able to further control the device via their smart device.

The remote is also comprised of at least one power button. The power button turns the motor on/off which then rotates the blades. The remote is also comprised of at least one fan control. These fan controls allow the user to change the speed in which the motor rotates the blades. The remote is also comprised of at least one light power button. The light power button turns the lights on/off. The remote is also comprised of at least one light control. The light controls allow a user to customize the lights. The remote is also comprised of at least one music power button. This button allows the user to turn the speaker on/off. The remote is further comprised of at least one music control. The music controls allow the user to change the volume of the music coming through the speaker as well as change the song that is playing through the speakers. The remote may be comprised of at least one battery that powers the remote. In one embodiment, the battery may be recharged via a charging port.

The mobile application preferably is comprised of music controls that allow the user to pick songs to play through the speaker, as well as change the volume of the speaker. The mobile application may also be comprised of light controls that will allow the user to customize the lights. The mobile application is further in wireless electronic communication with the receiver positioned in the housing.

Accordingly, the ceiling fan device of the present invention is particularly advantageous as it provides a customizable ceiling fan device that allows the user to play music to help the user better relax. In this manner, the ceiling fan device overcomes the limitations of existing ceiling fans known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a ceiling fan device of the present invention in accordance with the disclosed architecture;

FIG. 2 illustrates an enhanced perspective view of one potential embodiment of a ceiling fan device of the present invention in accordance with the disclosed architecture;

FIG. 3 illustrates a perspective view of one potential embodiment of a remote for a ceiling fan device of the present invention in accordance with the disclosed architecture; and

FIG. 4 illustrates a graphical view of one potential embodiment of a mobile application of one potential embodiment of a ceiling fan device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved ceiling fan. There also exists a long-felt need in the art for a ceiling fan device that has remote operating capabilities. In addition, there exists a long-felt need in the art for a ceiling fan device that allows a user to relax by cooling down a room while simultaneously playing music or sounds of their choice. There also exists a long-felt need in the art for a ceiling fan device that has the ability to play music or other sounds. Further, there exists a long-felt need in the art for a ceiling fan device that has lights that are customizable by the user.

The present invention, in one exemplary embodiment, is comprised of a ceiling fan device. The device is primarily comprised of a housing, at least one blade, at least one mount, at least one speaker, at least one light, at least one motor, a remote, and a mobile application. The blades are further attached to the housing via at least one fastener. In the preferred embodiment, the blades are removable and interchangeable for further customization. The housing is also comprised of a receiver that is in wireless electrical communication with a transmitter positioned in the remote as well as a mobile application on the user's smart device. The remote and the mobile application allow for the user to control the lights, speaker, and motor positioned within the housing.

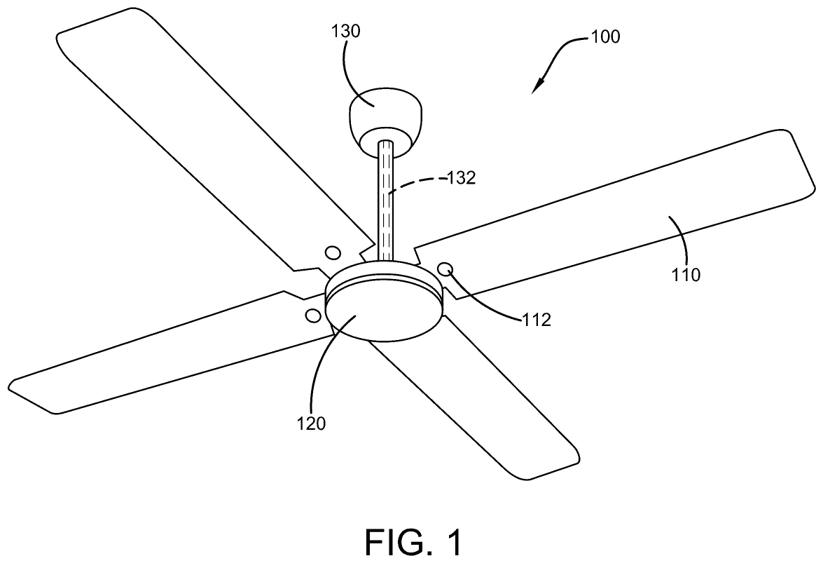

Referring initially to the drawings, FIG. 1 illustrates a perspective view of one potential embodiment of a ceiling fan device 100 of the present invention in accordance with the disclosed architecture. The device 100 is primarily comprised of at least one housing 120, at least one blade 110, and at least one mount 130.

The blades 110 are preferably manufactured from a rigid plastic material such as, but not limited to: acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In another embodiment, the blades 110 may be manufactured from any material known in the art such as, but not limited to, wood or metal. In differing embodiments, there may be any number of blades 110 on the device 100. The blades 110 may be aligned in any orientation, arrangement, and/or position known in the art. Further, the blades 110 may be any shape or design known in the art.

The blades 110 are attached to the housing 120 of the device 100 via at least one fastener 112. There are a plurality of fasteners 112 that may be used such as, but not limited to: a magnet, a screw, a bolt, an adhesive, a hook and loop fastener, a tongue and groove fastener, a screw, a nut, a bolt, a carriage bolt, a nail, an anchor bolt, an acorn nut, a threaded rod, a retaining ring, a rivet, a set screw, a toggle bolt, an anchor, a self-tapping screw, an adhesive, a u-bolt, a lock nut, a castle nut, etc. In the preferred embodiment, the blades 110 are removable and interchangeable such that the user could further customize the device 100.

The housing 120 is preferably manufactured from any metal material known in the art such as, but not limited to, aluminum, tin, stainless steel, or combinations therein. The housing 120 has at least one speaker 126, at least one light 122, at least one receiver 128, and at least one motor 124. The housing 120 may be any shape or orientation known in the art. The device 100 also has internal electrical wiring 132 that supplies power to all components of the device 100.

The device 100 is also comprised of a mount 130 that attaches the device 100 to a ceiling 10. The mount 130 may be attached to the ceiling 10 via a plurality of fastening means such as, but not limited to, a magnet, a screw, a nut, a bolt, a carriage bolt, a nail, an anchor bolt, an acorn nut, a threaded rod, a retaining ring, a rivet, a set screw, a toggle bolt, an anchor, a self-tapping screw, an adhesive, a u-bolt, a lock nut, a castle nut, or combinations thereof.

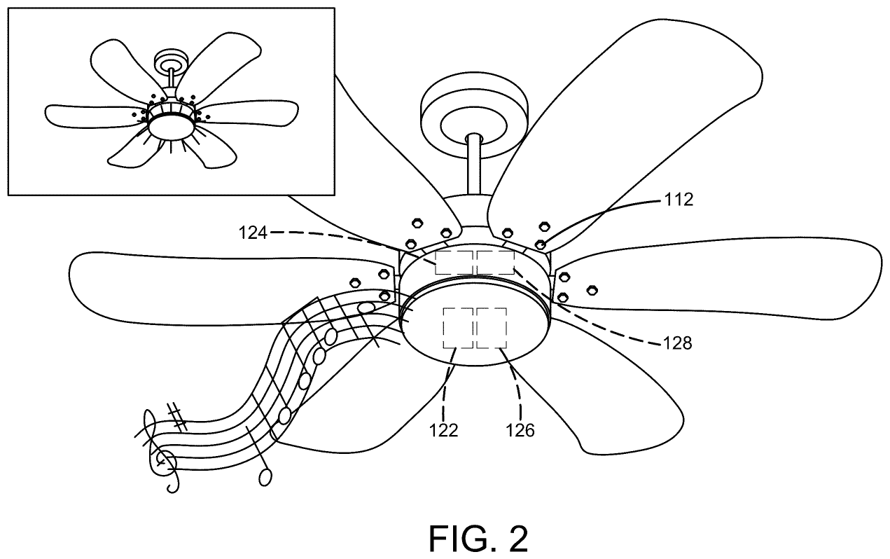

FIG. 2 illustrates an enhanced perspective view of one potential embodiment of a ceiling fan device 100 of the present invention in accordance with the disclosed architecture. The device 100 is comprised of at least one speaker 126, at least one motor 124, at least one light 122, and at least one receiver 128.

In the preferred embodiment, the light 122 is positioned within the housing 120 of the device 100. The light 122 may be any light source known in the art such as, but not limited to, LED light, LCD light, fluorescent light, white light, spotlight, area light, fiber optic illuminator, incandescent, halogen, etc. In a differing embodiment, the light 122 may be positioned outside the housing 120. In either embodiment, the light 122 may be customizable to allow the user to be able to change the color and/or brightness of the light 122. The functions of the light 122 are preferably controllable via a remote 200 that is in wireless electrical communication with the light 122 via at least one transmitter 260 positioned in the remote 200 and at least one receiver 128 positioned in the housing 120 and/or the light 122. In the preferred embodiment, the light 122 may have any number of brightness levels and colors known in the art. In another embodiment, the functions of the light 122 such as luminosity, brightness, and color may be controlled via a mobile application 300 on a user's smart device, wherein the mobile application 300 performs the same functions as the remote 200.

The device 100 is also comprised of at least one motor 124. The motor 124 powers the device 100 to rotate the blades 110 around the housing 120. The motor 124 may have a plurality of speeds such as, but not limited to, low, medium, and high to make the blades 110 rotate at different speeds. The motor 124 may be any motor known in the art such as, but not limited to, a brushed DC motor, brushless DC motor, micro stepped motor, linear stepped motor, shunt motor, series motor, compound motor, AC motor, PDMC motor, induction motor, synchronous motor, hysteresis motor, reluctance motor, etc. The motor 124 may also be controlled via the remote 200 that is in wireless electrical communication with the motor 124 via a transmitter 260 positioned in the remote 200 and a receiver 128 positioned in the housing 120.

The device 100 is also comprised of at least one speaker 126. The speaker 126 is preferably positioned within the housing 120, but in differing embodiments may be positioned outside of the housing 120. The speaker 126 may be any speaker known in the art. In the preferred embodiment, the speaker 126 has a plurality of different sound controls configurable via the remote 200. In another embodiment, the speaker 126 may be controlled via a mobile application 300 on the user's smart device that performs the same functions as the remote 200.

The device 100 is also comprised of at least one receiver 128 positioned within the housing 120 of the device 100. The receiver 128 may be any receiver known in the art. The receiver 128 is in electrical communication with at least one transmitter 260 located in the remote 200. This allows for the transmitter 260 to wirelessly communicate with the receiver 126, which then wirelessly communicates with the speaker 126, motor, 124, and light 122. The speaker 126, motor 124, or light 122 then executes the appropriate function that was selected on the remote 200. The receiver 128 is also in electrical communication with the mobile application 300 on the user's smart device. This allows the user to further control the device 100 via the mobile application 300 if the remote 200 is lost. In different embodiments the electronical communication capabilities of the device 100 may be, but are not limited to, GPS, WIFI, Bluetooth, RFID, cellular, etc.

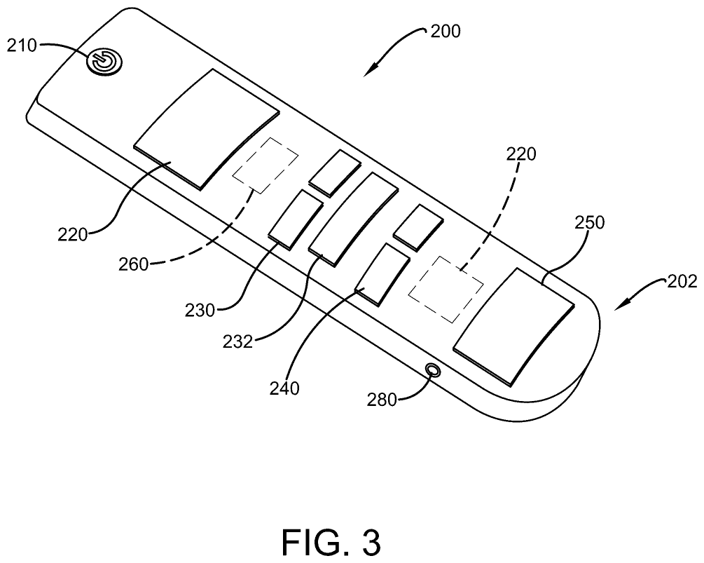

FIG. 3 illustrates a perspective view of one potential embodiment of a remote 200 for a ceiling fan device 100 of the present invention in accordance with the disclosed architecture. The remote 200 is primarily comprised of at least one power button 210, at least one fan control 220 that allows a user to turn/off the motor 124 and control fan speed, at least one light power button 230 that allows a user to turn the light 122 on/off, at least one light control 232 that allows a user to control the brightness and color of the light 122, at least one music power button 240 that allows a user to turn the speaker 126 on/off, at least one music control 250 that allows a user to select what is played by the speaker 126, at least one transmitter 260, at least one battery 270, and at least charging port 280. All controls 210,220,230,232,240,250 of the remote 200 may be present on the mobile application 300.

The body 202 of the remote 202 is preferably manufactured from a durable rigid plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The body 202 further may be manufactured in any shape known in the art, but in the preferred embodiment it is rectangular in shape.

The remote 200 is comprised of at least one transmitter 260. The transmitter 260 may be any transmitter known in the art. Further, the transmitter 260 is in wireless electrical communication with the receiver 128. In different embodiments the electronical communication capabilities of the device 100 could be, but are not limited to: GPS, WIFI, Bluetooth, RFID, cellular, etc. The remote 200 further is comprised of a plurality of controls and buttons. When these controls or buttons are pressed, the transmitter 220 electrically communicates with the receiver 128 that the button/control has been pressed.

The remote 200 is also comprised of at least one power button 210. The power button 210 turns the motor 124 on/off which then rotates the blades 110. The remote 200 is also comprised of at least one fan control 220. These fan controls 220 allow the user to change the speed in which the motor 124 rotates the blades 110. There may be a plurality of fan controls such as, low speed, middle speed, and high speed.

The remote 200 is also comprised of at least one light power button 230. The light power button 130 turns the lights 122 on/off. The remote is also comprised of at least one light control 232. The light controls 232 allow a user to customize the lights 122. The light controls 232 may be in the form of multiple buttons or sliders allowing the user to change the light 122 colors, or functionality.

The remote 200 is also comprised of at least one music power button 230. This button allows the user to turn the speaker 126 on/off. The remote 200 is further comprised of at least one music control 250. The music controls 250 allow the user to change the volume of the music coming through the speaker 126 as well as change the song that is playing through the speakers 126. The remote 200 is also comprised of a plurality of indicia 290 such as, but not limited to, designs, symbols, words, numbers, letters, pictures, etc.

The remote 200 may be comprised of at least one battery 270 that powers the remote 200. The battery 270 can be in the form of an alkaline, nickel-cadmium, nickel-metal hydride battery, etc., such as any 3V-12-volt DC battery 270 or other conventional battery 270 such as A, AA, AAA, etc., that supplies power to the remote 200. Throughout this specification, the terms “battery” and “batteries” may be used interchangeably to refer to one or more wet or dry cells or batteries 270 of cells in which chemical energy is converted into electricity and used as a source of DC power. References to recharging or replacing batteries 270 may refer to recharging or replacing individual cells, individual batteries 270 of cells, or a package of multiple battery cells as is appropriate for any given battery 270 technology that may be used. In one embodiment, the battery may be recharged via a charging port 280. The charging port 280 may be any charging port known in the art such as, but not limited to, USB-A, USB-B, Micro-B, Micro-USB, Mini-USB, USB-C, or a 9v/12v power supply.

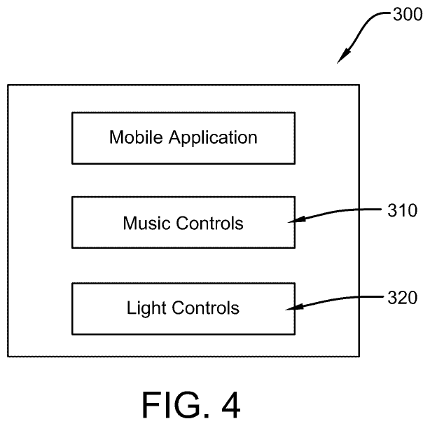

FIG. 4 illustrates a graphical view of one potential embodiment of a mobile application 300 of one potential embodiment of a ceiling fan device 100 of the present invention in accordance with the disclosed architecture. The mobile application 300 preferably may have music controls 310 that allow the user to pick songs to play through the speaker 126, as well as change the volume of the speaker 126. The mobile application 300 may be comprised of light controls 320 that will allow the user to customize the lights 122 such as, but not limited to, changing the color, luminosity, brightness, or combinations thereof. The mobile application 200 is further in electronic communication with the receiver 128 positioned in the housing 120.

In one embodiment of the device 100, the device 100 may be a free-standing fan, a box fan, or any other fan type known in the art.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ceiling fan device” and “device” are interchangeable and refer to the ceiling fan device 100 of the present invention.

Notwithstanding the foregoing, the ceiling fan device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the ceiling fan device 100 as shown in the FIGS. are for illustrative purposes only, and that many other sizes and shapes of the ceiling fan device 100 are well within the scope of the present disclosure. Although the dimensions of the ceiling fan device 100 are important design parameters for user convenience, the ceiling fan device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ceiling fan device comprising:
a housing;
a light;
a speaker;
a receiver;
a blade;
a mount; and
a remote comprised of a transmitter.

2. The ceiling fan device of claim 1, wherein the blade is comprised of a removable fastener.

3. The ceiling fan device of claim 1, wherein the housing is comprised of a motor.

4. The ceiling fan device of claim 3, wherein the motor is comprised of a brushed DC motor, a brushless DC motor, a micro stepped motor, a linear stepped motor, a shunt motor, a series motor, a compound motor, an AC motor, a PDMC motor, an induction motor, a synchronous motor, a hysteresis motor or a reluctance motor.

5. The ceiling fan device of claim 1, wherein the remote is comprised of a power button.

6. The ceiling fan device of claim 1, wherein the remote is comprised of a music power button.

7. The ceiling fan device of claim 1, wherein the remote is comprised of an indicia.

8. The ceiling fan device of claim 7, wherein the indicia is comprised of a design, a symbol, a word, a number, a letter or a picture.

9. The ceiling fan device of claim 1, wherein the remote further comprises a battery.

10. The ceiling fan device of claim 1, wherein the ceiling fan device is comprised of an electrical wiring.

11. A ceiling fan device comprising:
a housing;
a light;
a speaker;
a motor;
a receiver;
a blade;
a removable fastener;
a mount; and
a remote comprised of a power button, a music power button, an indicia, a battery and a transmitter.

12. The ceiling fan device of claim 11, wherein the remote is comprised of a light control.

13. The ceiling fan device of claim 12, wherein the remote is comprised of a music control.

14. The ceiling fan device of claim 13, wherein the remote is comprised of a charging port.

15. The ceiling fan device of claim 14, wherein the charging port is comprised of a USB-A, a USB-B, a Micro-B, a Micro-USB, a Mini-USB, a USB-C, or a 9v/12v power supply.

16. The ceiling fan device of claim 11, wherein the transmitter of the remote is in wireless electrical communication with the receiver, and further wherein the receiver is positioned in the housing.

17. The ceiling fan device of claim 16, wherein the electrical communication is comprised of a GPS, a WIFI, a Bluetooth, a RFID or a cellular communication.

18. A ceiling fan device comprising:
a housing comprised of a light, a speaker, a motor and a receiver;
a blade comprised of a removable fastener;
a mount;
a remote comprised of a power button, a music power button, an indicia, a battery, and a transmitter; and
a mobile application.

19. The ceiling fan device of claim 18, wherein the mobile application is comprised of a music control.

20. The ceiling fan device of claim 18, wherein the mobile application is comprised of a light control.
